(19) United States
(12) Patent Application Publication
(10) Pub. No.: US 2026/0149032 A1
(43) Pub. Date: May 28, 2026

(54) NEGATIVE ELECTRODE FOR RECHARGEABLE LITHIUM BATTERY, METHOD FOR MANUFACTURING THE SAME, AND RECHARGEABLE LITHIUM BATTERIES INCLUDING THE SAME

(71) Applicant: SAMSUNG SDI CO., LTD., Yongin-si (KR)

(72) Inventor: Taeguan KIM, Yongin-si (KR)

(73) Assignee: SAMSUNG SDI CO., LTD., Yongin-si (KR)

(21) Appl. No.: 19/396,794

(22) Filed: Nov. 21, 2025

(30) Foreign Application Priority Data
Nov. 28, 2024 (KR) 10-2024-0174129

(51) Int. Cl. H01M 10/0525; H01M 4/02; H01M 4/04; H01M 4/133; H01M 4/134; H01M 4/1393; H01M 4/1395; H01M 4/38; H01M 4/587; H01M 4/62

(52) U.S. Cl. CPC H01M 10/0525; H01M 4/0404; H01M 4/133; H01M 4/134; H01M 4/1393; H01M 4/1395; H01M 4/386; H01M 4/587; H01M 4/62; H01M 2004/021; H01M 2004/027

(57) ABSTRACT

Disclosed are a negative electrode for a rechargeable lithium battery, a method for manufacturing the negative electrode, and a rechargeable lithium battery including the negative electrode. The negative electrode for a rechargeable lithium battery includes a negative electrode current collector; and a negative electrode active material layer disposed on the negative electrode current collector and including a negative electrode active material. The negative electrode active material is arranged in a vertical direction of the negative electrode current collector, the negative electrode active material layer has a lithium ion movement path between negative electrode active materials arranged in a vertical direction, and the lithium ion movement path has a width in a range of about 1 μm to about 50 μm.

### CROSS-REFERENCE TO RELATED APPLICATION

This application claims priority to Korean Patent Application No. 10-2024-0174129 filed with the Korean Intellectual Property Office on Nov. 28, 2024, the entire contents of which are incorporated herein by reference.

### BACKGROUND

### 1. Field

A negative electrode for a rechargeable lithium battery, a method for manufacturing the negative electrode, and a rechargeable lithium battery including the negative electrode are disclosed.

### 2. Description of the Related Art

Rechargeable lithium batteries, which are portable as well as exhibit high energy density, are used as power sources for mobile information terminals such as, e.g., smart phones, laptops, and the like. Providing rechargeable lithium batteries with high energy density for the use as power sources for, e.g., hybrid vehicles and electric vehicles, or for storing electric power may be advantageous.

In order to develop an electrode for a rechargeable lithium battery that exhibits high energy density, an amount of active material is increased to increase a thickness of the electrode active material layer. However, the diffusion distance of lithium ions may also increase in proportion to the thickness of the electrode active material layer, thereby deteriorating battery performance.

One of the main causes of increased internal resistance in batteries is increased tortuosity, which causes the lithium ion movement path to become more twisted, making charge and discharge reactions more uneven, and accelerating battery degradation. The tortuosity refers to the actual movement distance of lithium ions in the vertical direction from the surface of the electrode plate to the negative electrode current collector. A higher tortuosity means a higher internal resistance, meaning that the movement distance of lithium ions has actually increased.

Accordingly, providing a plate that reduces the tortuosity of the negative electrode plate while exhibiting high energy density, thereby improving or optimizing the lithium ion movement path during battery charging and discharging, and reducing or suppressing an increase in internal resistance and a decrease in rapid charging performance, may be advantageous.

### SUMMARY

Some example embodiments include a negative electrode for a rechargeable lithium battery that exhibits high energy density while reducing tortuosity to improve or optimize the lithium ion movement path during battery charging and discharging, thereby reducing or suppressing an increase in internal resistance and a decrease in rapid charging performance.

Some example embodiments include a method for manufacturing a negative electrode for a rechargeable lithium battery.

Some example embodiments include a rechargeable lithium battery including the negative electrode for the rechargeable lithium battery.

In some example embodiments, a negative electrode for a rechargeable lithium battery includes a negative electrode current collector, and a negative electrode active material layer disposed on the negative electrode current collector and including a negative electrode active material. The negative electrode active material is arranged in a vertical direction of the negative electrode current collector, the negative electrode active material layer has a lithium ion movement path between the negative electrode active materials arranged in the vertical direction, and the lithium ion movement path has a width in a range of about 1 μm to about 50 μm.

In some example embodiments, a method for manufacturing a negative electrode for a rechargeable lithium battery includes preparing a composition for forming a negative electrode active material layer including a negative electrode active material and a surfactant, coating the composition for forming a negative electrode active material layer onto a surface of a negative electrode current collector, arranging the negative electrode active material in a vertical direction of the negative electrode current collector by a magnetic field and arranging the surfactant between the negative electrode active materials arranged in the vertical direction, and drying the surfactant.

In some example embodiments, a rechargeable lithium battery including a positive electrode, the aforementioned negative electrode, and an electrolyte, is provided.

According to some example embodiments, the negative electrode for a rechargeable lithium battery may exhibit high energy density while reducing tortuosity, thereby improving or optimizing the lithium ion movement path during battery charging and discharging, and reducing or suppressing an increase in internal resistance and a decrease in rapid charging performance.

### BRIEF DESCRIPTION OF THE DRAWINGS

FIG. 1 is a schematic view showing the lithium ion movement path in a conventional negative electrode.

FIG. 2 is a schematic view showing the lithium ion movement path in a negative electrode according to some example embodiments.

FIG. 3A to FIG. 3C are schematic views showing a method for manufacturing a negative electrode according to some example embodiments.

FIG. 4 to FIG. 7 are schematic views illustrating rechargeable lithium batteries according to some example embodiments.

FIG. 8 is a flowchart illustrating a method of manufacturing a negative electrode for a rechargeable lithium battery, according to example embodiments.

### DETAILED DESCRIPTION

Hereinafter, example embodiments are described in detail so that those of ordinary skill in the art can readily implement them. However, this disclosure may be embodied in many different forms and is not construed as limited to the example embodiments set forth herein.

The terminology used herein is used to describe example embodiments only and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but do not preclude the possibility of the presence or addition of one or more other features, number, step, element, or a combination thereof.

In the drawings, the thickness of layers, films, panels, regions, and the like, are exaggerated for clarity, and like reference numerals designate like elements throughout the specification. It is understood that when an element such as a layer, film, region, or substrate is referred to as being “on” another element, the element can be directly on the other element, or intervening elements may also be present therebetween. In contrast, when an element is referred to as being “directly on” another element, no intervening elements may be present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may indicate the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Negative Electrode

Some example embodiments include a negative electrode for a rechargeable lithium battery which includes a negative electrode current collector, and a negative electrode active material layer disposed on the negative electrode current collector and including a negative electrode active material. The negative electrode active material is arranged in a vertical direction of the negative electrode current collector, and the negative electrode active material layer has a lithium ion movement path between the negative electrode active materials arranged in the vertical direction.

To achieve high energy density, an amount of negative electrode active material is increased, and accordingly, the thickness of the negative electrode plate increases. As the thickness of the negative electrode plate increases, the lithium ion movement path increases, and the internal resistance increases due to the increase in tortuosity, causing uneven charging and discharging, which reduces battery performance.

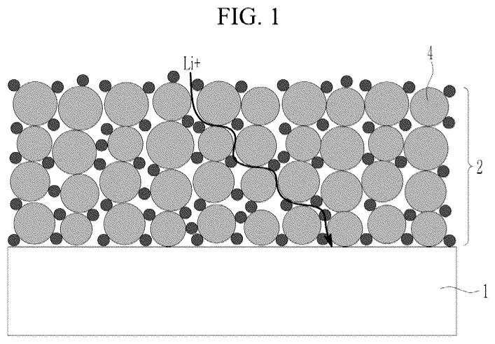

FIG. 1 is a schematic view showing the lithium ion movement path in a conventional negative electrode. As described above, in order to implement high energy density, the amount of negative electrode active material 4 is increased, and the negative electrode active material 4 is densely present in the negative electrode active material layer 2 so that the lithium ion movement path is twisted and the degree of tortuosity increases.

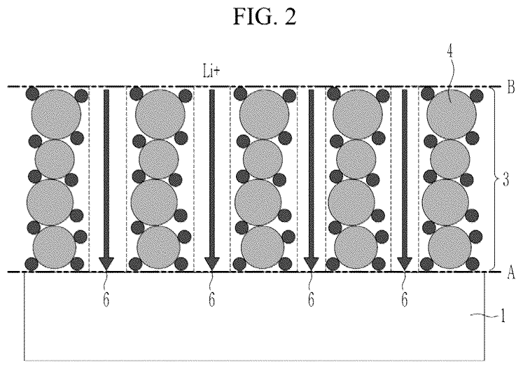

However, some example embodiments include a negative electrode that solves this problem. FIG. 2 is a schematic view showing the lithium ion movement path in a negative electrode according to some example embodiments. Unlike FIG. 1, the negative electrode according to some example embodiments includes a negative electrode active material 4 arranged in a vertical direction of a negative electrode current collector 1 and a lithium ion movement path 6 between the negative electrode active materials arranged in the vertical direction.

Herein, the fact that the negative electrode active material 4 is arranged in the vertical direction of the negative electrode current collector 1 may mean that the negative electrode active material 4 particles are arranged in rows perpendicular, or substantially perpendicular, to the negative electrode current collector 1, as shown in FIG. 2. Herein, the vertical direction includes not only the case where the negative electrode current collector and the negative electrode active material rows form a 90° angle, but also the case where the negative electrode current collector and the negative electrode active material rows are approximately vertical, for example, the case where the negative electrode current collector and the negative electrode active material rows form an angle of about 90±10°. In addition, as an example, the negative electrode active material may have a shape such as an elliptical sphere having a sphericity that is less than about 1, and the long axis of the elliptical spherical particles may be aligned in a direction approximately perpendicular to the negative electrode current collector by the action of a magnetic field, and the like. In this case, the negative electrode active material may also be aligned in the vertical direction of the negative electrode current collector.

In addition, the lithium ion movement path 6 may indicate a path through which ions move, and for example, may indicate a path through which lithium ions move. The lithium ion movement path 6 may be formed in a direction approximately perpendicular to the negative electrode current collector 1. For example, a negative electrode according to one example embodiment may include a negative electrode current collector 1, rows of negative electrode active materials 4 arranged in a direction approximately perpendicular to the negative electrode current collector 1, and a lithium ion movement path 6 between the rows of negative electrode active materials.

The lithium ion movement path 6 is positioned between the negative electrode active materials 4 and is formed in a direction approximately perpendicular to the negative electrode current collector 1 with a desired or predetermined width, thereby facilitating the movement of lithium ions and shortening the movement distance of lithium ions, and improving rapid charging performance and output characteristics. Accordingly, the negative electrode according to some example embodiments may improve or optimize the lithium ion movement path during battery charging and discharging by reducing the degree of tortuosity while exhibiting high energy density, thereby reducing or suppressing an increase in internal resistance and a decrease in rapid charging performance. The lithium ions may move through the lithium ion movement path, thereby improving or optimizing the lithium ion movement path.

A width of the movement path is in a range of about 1 μm to about 50 μm. For example, the width of the lithium ion movement path may be about 2 μm to about 47 μm, about 3 μm to about 45 μm, about 4 μm to about 40 μm, or about 5 μm to about 36 μm. The width of the lithium ion movement path may indicate the shortest distance between vertically arranged negative electrode active materials and adjacent vertically arranged negative electrode active materials. When the width of the lithium ion movement path satisfies the above range, high energy density can be achieved while reducing the degree of tortuosity, thereby improving or optimizing the lithium ion movement path during battery charging and discharging, and reducing or suppressing an increase in internal resistance and a decrease in rapid charging performance. In addition, when the width of the lithium ion movement path satisfies the above range, challenges such as changes in the volume of the negative electrode due to repeated charge and discharge, resulting in cracks, detachment of the negative electrode, or deterioration of cycle-life characteristics, may be effectively reduced or suppressed. For example, when the width of the lithium ion movement path is less than about 1 μm, the effect of increasing internal resistance may be minimal, and when the width of the lithium ion movement path is more than about 50 μm, the density of the negative electrode active material layer may decrease, resulting in a lower energy density or reduced durability, which may result in a deterioration in performance such as cycle-life characteristics. The width of the lithium ion movement path may be measured by taking a cross-section of the negative electrode using a scanning electron microscope (SEM) and measuring the spacing between vertically arranged negative electrode active materials.

### Negative Electrode Current Collector

The negative electrode current collector is not particularly limited as long as the negative electrode current collector has conductivity and does not cause an adverse chemical change in the rechargeable lithium battery, and the negative electrode current collector may be or include at least one of a copper foil, a nickel foil, a stainless-steel foil, a titanium foil, a nickel foam, a copper foam, a polymer substrate coated with a conductive metal, and a combination thereof.

### Negative Electrode Active Material Layer

The negative electrode active material layer includes negative electrode active materials arranged in a vertical direction of the negative electrode current collector and lithium ion movement paths between the negative electrode active materials arranged in the vertical direction.

The negative electrode active material may include at least one of a material capable of reversibly intercalating/deintercalating the lithium ions, a lithium metal, a lithium metal alloy, a material being capable of doping/dedoping lithium. or a transition metal oxide.

The material capable of reversibly intercalating/deintercalating the lithium ions may be or include a carbon-based negative electrode active material. In some example embodiments, the negative electrode active material may include a carbon-based negative electrode active material.

The carbon-based negative electrode active material may include crystalline carbon, amorphous carbon, or a combination thereof. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like. The soft carbon refers to a carbon material that can be graphitized, and is a material that is readily graphitized by heat treatment at a high temperature, for example, of about 2800° C. The hard carbon is a carbon material that cannot be graphitized, or that is finely graphitized by heat treatment.

The negative electrode active material layer may further include other types of negative electrode active materials in addition to the carbon-based negative electrode active material, and may further include, for example, a lithium metal, an alloy of lithium metal, a material capable of doping and dedoping lithium, and the like.

As the above lithium metal alloy, an alloy of lithium and a metal such as or including at least one of Na, K, Rb, Cs, Fr, Be, Mg, Ca, Sr, Si, Sb, Pb, In, Zn, Ba, Ra, Ge, Al and Sn may be used.

The material capable of doping and dedoping the lithium, a silicon-based negative electrode active material or a tin-based negative electrode active material may be used. The silicon-based negative electrode active material may include at least one of silicon, a silicon-carbon composite, SiOₓ (0<x≤2), a Si-Q alloy (wherein Q is an element such as or including at least one of an alkali metal, an alkaline earth metal, a Group 13 element, a Group 14 element, a Group 15 element, a Group 16 element, a transition metal, a rare earth element and a combination thereof, but is not Si). The Sn-based negative electrode active material may include at least one of Sn, SnO₂, an Sn—R alloy (wherein R is an element such as or including at least one of an alkali metal, an alkaline earth metal, a Group 13 element, a Group 14 element, a Group 15 element, a Group 16 element, a transition metal, a rare earth element and a combination thereof, but is not Sn). In addition, at least one of the above elements may be mixed with SiO₂. The elements Q and R may be or include at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. The average particle diameter (D₅₀) of the silicon-carbon composite particles may be in a range of, for example, about 0.5 μm to about 20 μm. The average particle diameter (D₅₀) is measured with a particle size analyzer and indicates a diameter of particles with a cumulative volume of 50 volume % in the particle size distribution. The silicon may be included in an amount in a range of about 10 wt % to about 60 wt %, and the carbon may be included in an amount in a range of about 40 wt % to about 90 wt % based on 100 wt % of the silicon-carbon composite particles. For example, the silicon-carbon composite particles may include a core including silicon particles, and a carbon coating layer on the surface of the core. An average particle diameter (D₅₀) of the silicon particles may be in a range of about 10 nm to about 1 μm, or a range of about 10 nm to about 200 nm in the core. The silicon particles may be in the form of silicon alone, in the form of a silicon alloy, or in an oxidized form. The oxidized form of silicon may be represented by SiOₓ (0<x<≤2). In addition, a thickness of the carbon coating layer may be in a range of about 5 nm to about 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not be present in the core, but only in the carbon coating layer. The crystalline carbon may be or include artificial graphite, natural graphite, or a combination thereof, and the amorphous carbon may be formed from at least one of coal-based pitch, mesophase pitch, petroleum-based pitch, coal-based oil, heavy petroleum oil, or a polymer resin (phenol resin, furan resin, polyimide resin, and the like). Herein, an amount of the crystalline carbon may be in a range of about 10 wt % to about 70 wt %, and an amount of the amorphous carbon may be in a range of about 20 wt % to about 40 wt % based on 100 wt % of the silicon-carbon composite particles.

In the silicon-carbon composite particle, the core may include pores in the center. A radius of the pore may be in a range of about 30 length % to about 50 length % of the radius of the silicon-carbon composite particle.

The aforementioned silicon-carbon composite particles effectively reduce or suppress problems such as volume expansion, structural collapse, or particle crushing due to charging and discharging, reduce or prevent disconnection of conductive paths, achieve high capacity and high efficiency, and is advantageous to use under a high-voltage or high-rate charging conditions.

The silicon-based negative electrode active material or tin-based negative electrode active material may be used in a mixture with a carbon-based negative electrode active material. When using a silicon-based negative electrode active material or a tin-based negative electrode active material and a carbon-based negative electrode active material in combination, a mixing ratio may be in a range of about 1:99 to about 90:10 by weight.

In some example embodiments, the negative electrode active material layer may include a carbon-based negative electrode active material, a silicon-based negative electrode active material, or a combination thereof. For example, the negative electrode active material may include a carbon-based negative electrode active material, and may further include a silicon-based negative electrode active material. When applying a carbon-based negative electrode active material, it is possible to orient the carbon-based negative electrode active material with a magnetic field as in the negative electrode manufacturing process described below, and accordingly, it is advantageous to implement an array of negative electrode active materials aligned vertically on the negative electrode current collector and a lithium ion movement path located therebetween. In addition, when applying a combination of a carbon-based negative electrode active material and a silicon-based negative electrode active material, it is advantageous in implementing a high capacity and increasing energy density while implementing a vertically aligned negative electrode active material array on a negative electrode current collector, which is a negative electrode structure according to some example embodiments, and a lithium ion movement path therebetween. The lithium ion movement path may effectively reduce or suppress the challenge of cracking or detachment of the negative electrode active material layer caused by volume change due to charge/discharge of the silicon-based negative electrode active material.

An amount of the negative electrode active material in the negative electrode active material layer may be in a range of about 90 wt % to about 99.9 wt %, or about 95 wt % to about 99 wt %, based on 100 wt % of the negative electrode active material layer.

The negative electrode active material layer may optionally further include a binder, a conductive material, or a combination thereof, together with the negative electrode active material.

The binder attaches the negative electrode active material particles to each other, and attaches the negative electrode active material to the negative electrode current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material capable of being fibrous, and may be or include, for example, at least one of polytetrafluoroethylene, polyvinylidene fluoride, a polyvinylidene fluoride-hexafluoropropylene copolymer, polyethylene oxide, or a combination thereof.

The conductive material may provide conductivity to the electrode, and any material that does not cause an adverse chemical change and is electronically conductive can be used in the battery being constructed. Examples of the conductive material include a carbon-based material such as at least one of natural graphite, artificial graphite, carbon black, acetylene black, Ketjen black, a carbon fiber, a carbon nanofiber, a carbon nanotube, and the like; a metal-based material of a metal powder or a metal fiber including at least one of copper, nickel, aluminum silver, and the like; a conductive polymer such as a polyphenylene derivative; or a mixture thereof.

The negative electrode active material may be included in an amount in a range of about 90 wt % to about 99.8 wt %, or about 94 wt % to about 99 wt %, based on 100 wt % of the negative electrode active material layer, the binder may be included in an amount in a range of about 0.1 wt % to about 5 wt %, or about 0.5 wt % to about 3 wt %, based on 100 wt % of the negative electrode active material layer, and the conductive material may be included in an amount in a range of about 0.1 wt % to about 5 wt %, or about 0.5 wt % to about 3 wt %, based on 100 wt % of the negative electrode active material layer.

As illustrated in FIG. 2, the lithium ion movement path is located between the negative electrode active materials arranged in a vertical direction. The lithium ion movement path may be in the vertical direction of the negative electrode current collector. For example, negative electrode active material particles may be arranged in rows in a direction approximately perpendicular to the negative electrode current collector, and lithium ion movement paths of a desired or predetermined width may be formed between the rows of negative electrode active material. Herein, the lithium ion movement path being perpendicular to the negative electrode current collector may mean that the straight line connecting both ends of the lithium ion movement path and the current collector form an angle of about 90±10°. The straight line connecting both ends of the lithium ion movement path and the current collector may form an angle of, for example, about 90±5°, or about 90±1°.

The lithium ion movement path may have an open structure, for example, by connecting one side (side A) of the negative electrode active material layer in contact with the negative electrode current collector to another side (opposite side; side B) facing the one side. In this way, when the lithium ion movement path has a structure in which both sides are open, the movement distance of lithium ions in the negative electrode active material layer is shortened, the transfer of lithium ions is facilitated, and the overall performance of the battery is improved, and the rapid charging function and output characteristics may be improved.

As another example, the lithium ion movement path may be one-sided open, that is open on the A side but not open on the B side, or conversely, may be one-sided open, that is open on the B side but not open on the A side. In another example, the lithium ion movement path may be a non-open type that is not open to both the A side and the B side and extends inside the negative electrode active material layer. In any form, the lithium ion movement path may improve the performance of the battery by facilitating the movement of lithium ions within the negative electrode active material layer and shortening the movement distance of lithium ions.

The lithium ion movement path may exist in multiple numbers within the negative electrode active material layer. For example, the lithium ion movement path may be present in one negative electrode active material layer in the number of 1 to 100, for example, 2 to 80, 5 to 60, or 10 to 50.

For example, a ratio (b/a) of the width (b) of the lithium ion movement path to the width (a) of the negative electrode active material layer may be in a range of about 1% to about 30%, for example, about 1% to about 28%, about 1% to about 26%, about 1% to about 24%, about 1% to about 22%, or about 2% to about 20%. Because the lithium ion movement path extends so as to satisfy the above range relative to the width of the negative electrode active material layer, high energy density may be realized while reducing the degree of tortuosity, thereby improving or optimizing the movement path of lithium ions during battery charging and discharging, thereby reducing or suppressing an increase in internal resistance and a decrease in rapid charging performance.

A length of the lithium ion movement path may be in a range of about 5 μm to about 200 μm, for example about 10 μm to about 150 μm, about 20 μm to about 100 μm, about 30 μm to about 80 μm, or about 49 μm to about 75 μm. The length of the lithium ion movement path may be measured by taking a photograph of a cross-section of the negative electrode using a scanning electron microscope (SEM) and measuring the length of the lithium ion movement path located between vertically arranged negative electrode active materials in the vertical direction of the negative electrode current collector.

A thickness of the negative electrode active material layer may be in a range of, for example, about 20 μm to about 300 μm, about 30 μm to about 150 μm, or about 40 μm to about 100 μm. For example, because the lithium ion movement path is formed in the thickness direction of the negative electrode active material layer, the length thereof may be equal to or similar to the thickness of the negative electrode active material layer.

The negative electrode active material layer may improve the tortuosity of the lithium ion movement path compared to negative electrode active material layers having the same thickness. For example, the tortuosity of the lithium ion movement path in the negative electrode active material layer may be in a range of about 1 to about 3. The tortuosity is an indicator of the degree of curvature of pores within a porous material, and may be calculated by dividing the distance actually traveled by molecules moving within the pores by the straight-line distance between identical points. That is, when the tortuosity is about 1, the pore is a straight line in travel distance, and when the tortuosity is greater than 1, the pore has a severe curvature.

The negative electrode active material layer may have improved tortuosity compared to a negative electrode active material layer having the same thickness due to lithium ion movement paths between the negative electrode active materials arranged in a vertical direction. The lithium ion movement path may have, for example, a cylindrical pore shape with little or no curvature. The lithium ion movement path having such a pore structure can enable smooth movement of lithium ions. The cylindrical pore means a pore formed through the upper and lower surfaces of the negative electrode active material layer, having a circular or nearly circular cross-section on both the upper and lower surfaces, and having the same or very similar diameters of the cross-sections formed on each of the upper and lower surfaces.

When the degree of tortuosity of the lithium ion movement path in the above-mentioned negative electrode active material layer satisfies the above-mentioned range, high energy density may be achieved while improving or optimizing the movement path of lithium ions during battery charging and discharging, thereby reducing or suppressing an increase in internal resistance and a decrease in rapid charging performance.

According to some example embodiments, the negative electrode may have a short lithium ion diffusion distance and low tortuosity, and thus may have low ionic resistance and McMullin number. The internal resistance of the negative electrode can vary depending on the thickness of the negative electrode active material layer. For example, when the thickness of the negative electrode active material layer is 75±5 μm, the internal resistance (Rᵢₒₙ) of the negative electrode may be less than about 11.85 Ωcm², for example about 10.00 Ωcm² to about 11.75 Ωcm², or about 10.93 Ωcm² to about 11.73 Ωcm², and the McMullin number of the negative electrode may be less than about 14.27, for example, about 13.00 to about 14.25, or about 13.35 to about 14.15. As another example, when the thickness of the negative electrode active material layer is 50±5 μm, the internal resistance (Rᵢₒₙ) of the negative electrode may be less than about 11.20 Ωcm², and may be, for example, about 10.00 Ωcm² to about 11.15 Ωcm², or about 10.48 Ωcm² to about 11.13 Ωcm². The McMullin number of the negative electrode may vary depending on the thickness of the negative electrode active material layer, and when the thickness of the negative electrode active material layer is about 75±5 μm, the McMullin number of the negative electrode may be less than about 15.82, and may be, for example, about 14.5 to about 15.7, or about 15.05 to about 15.68. Meanwhile, when the thickness of the negative electrode active material layer is 50±5 μm, the internal resistance (Rᵢₒₙ) of the negative electrode may be less than about 14.27, and may be, for example, about 13 to about 14.2, or about 13.35 to about 14.15. The internal resistance may be calculated by multiplying the ionic resistance obtained through electrochemical impedance spectroscopy by the area of the electrode, and may be specifically measured by the method of Evaluation Example 1 described below. The definition and measurement method of the above McMullin number are the same as Evaluation Example 2 described below.

In some example embodiments, the negative electrode active material particles in the negative electrode active material layer may be arranged in a direction approximately perpendicular to the negative electrode current collector. For example, the negative electrode may have a Degree of Divergence (DD) value defined by Equation 1 that is greater than or equal to about 19, for example, about 19 to about 60, or about 30 to about 60.

### Equation 1:

$$DD ( Degree of Divergence ) = ( {I}_{a} / {I}_{total} ) \times 100. \qquad In Equation 1$$

Iₐ is a sum of peak intensities at non-planar angles measured by XRD using a CuKα ray, and

Iₜₒₜₐₗ is a sum of peak intensities at all angles measured by XRD using a CuKα ray.

The non-planar angles denote 2θ=42.4±0.2°, 43.4±0.2°, 44.6±0.2°, and 77.5±0.2°, when measured by XRD using a CuKα ray, that is, a (100) plane, a (101)R plane, a (101)H plane, and a (110) plane, respectively. In general, graphite has a structure classified into a rhombohedral structure and a hexagonal structure having an ABAB type of stacking sequence according to a stacking order of graphene layers, and the “R” plane denotes the rhombohedral structure, while the “H” plane denotes the hexagonal structure.

Thus, the Iₐ may be a sum of peak intensities at 2θ=42.4±0.2°, 43.4±0.2°, 44.6±0.2°, and 77.5±0.2° measured by XRD using a CuKα ray.

The all angles denote 2θ=26.5±0.2°, 42.4±0.2°, 43.4±0.2°, 44.6±0.2°, 54.7±0.2°, and 77.5±0.2° when measured by XRD using a CuKα ray, that is, a (002) plane, a (100) plane, a (101)R plane, a (101)H plane, a (004) plane, and a (110) plane. A peak at 2θ=43.4±0.2° may also be considered to appear by being overlapped with a peak of a (101) R plane of a carbon-based material with another peak of a (111) plane of a negative electrode current collector, for example, Cu.

Thus, the Iₜₒₜₐₗ may be a sum of peak intensities at 2θ=26.5±0.2°, 42.4±0.2°, 43.4±0.2°, 44.6±0.2°, 54.7±0.2°, and 77.5±0.2° measured by XRD using a CuKα ray.

In general, peak intensity indicates a height of a peak or an integral area of the peak, and according to some example embodiments, the peak intensity indicates the integral area of a peak.

In some example embodiments, the XRD is measured under a measurement condition of 2θ=10° to 80°, a scan speed (°/S) of 0.044 to 0.089, and a step size (°/step) of 0.013 to 0.039 by using a CuKα ray as a target ray but removing a monochromator to improve a peak intensity resolution.

The DD values indicates that the negative electrode active material included in the negative electrode active material layer are oriented at a desired or predetermined angle, and a larger value indicates that the negative electrode active material is oriented. That is, the larger the DD value, the greater the angle at which the negative electrode active material is oriented relative to one surface of the substrate (negative electrode current collector). Additionally, these DD values are maintained even when charging and discharging are performed.

In some example embodiments, the DD value of the negative electrode may be greater than or equal to about 19, for example, about 20 to about 60, about 25 to about 60, about 30 to about 60, about 30 to about 55, about 35 to about 55, or about 40 to about 55. The DD value of greater than or equal to about 19 of the negative electrode means that the negative electrode active material is substantially perpendicular to the negative electrode current collector, which means that the negative electrode active material layer of the negative electrode is an orientation layer. For example, a substantially perpendicular standing state does not necessarily mean standing at a about 90° angle with respect to the negative electrode current collector, but rather means standing at an angle close to about 90°, for example about 90±10°, about 90±5°, or about 90±1°.

When the DD value of the negative electrode is less than about 19, the included negative electrode active material layer corresponds to a non-oriented layer, or even when the negative electrode active material layer is an oriented layer, the expansion effect is low and thus not suitable.

The negative electrode active material layer may further include a surfactant. As described below, the negative electrode according to some example embodiments may further include a surfactant in the composition for forming the negative electrode active material layer, so that a lithium ion movement path is formed due to the surfactant, and although most of the surfactant is removed, the surfactant may remain without being completely removed. An amount of the surfactant remaining in the negative electrode active material layer may be less than or equal to about 5 wt %, less than or equal to about 1 wt %, or less than or equal to about 0.5 wt %, or greater than or equal to about 0 wt %, greater than or equal to about 0.01 wt %, or greater than or equal to about 0.05 wt %, based on 100 wt % of the negative electrode active material layer.

Accordingly, because the negative electrode active material is disposed vertically with respect to the negative electrode current collector, volume expansion may occur in the horizontal direction during charging and discharging of a battery including this negative electrode. Accordingly, it is possible to effectively reduce or suppress excessive vertical volume expansion that may occur when using a negative electrode active material including silicon, thereby significantly reducing the rate of increase in battery thickness and reducing or preventing the phenomenon of the negative electrode active material layer being detached from the negative electrode current collector. Therefore, a negative electrode active material including silicon that can improve energy density may be readily applied to a battery.

### Method for Manufacturing Negative Electrode for Rechargeable Lithium Battery

In some example embodiments, a method for manufacturing a negative electrode for a rechargeable lithium battery includes preparing a composition for forming a negative electrode active material layer including a negative electrode active material and a surfactant, coating the composition for forming a negative electrode active material layer onto a surface of a negative electrode current collector, arranging the negative electrode active material in a vertical direction of the negative electrode current collector by a magnetic field, and arranging the surfactant between the negative electrode active materials arranged in the vertical direction, and drying the surfactant. The negative electrode active material layer of the negative electrode manufactured according to the above method for manufacturing the negative electrode may include negative electrode active materials arranged in a vertical direction of the negative electrode current collector and lithium ion movement paths between the negative electrode active materials arranged in the vertical direction.

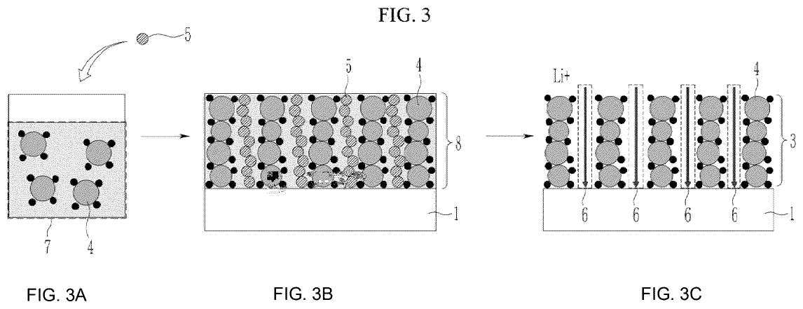

FIG. 3A to FIG. 3C are schematic views showing a method for manufacturing a negative electrode according to some example embodiments.

First, the composition for forming a negative electrode active material layer including the negative electrode active material and the surfactant is prepared (FIG. 3A).

Details of the negative electrode active material are described as above, and the composition for forming the negative electrode active material layer may be prepared optionally by dispersing a binder, a conductive material, or a combination thereof in addition to the aforementioned components in a solvent.

The solvent may be or include at least one of N-methylpyrrolidone (NMP), acetone, water, and the like. In some example embodiments, the solvent may be or include an aqueous solvent, for example, water. The solvent may be removed together with the surfactant in a step of drying the surfactant.

The solvent may be used in an amount in a range of about 1 part by weight to about 10 parts by weight based on 100 parts by weight of the negative electrode active material. When the solvent is used within the above range, an active material layer may be readily formed.

The preparation of the composition for forming a negative electrode active material layer including the negative electrode active material and the surfactant may be performed by mixing the solvent and the negative electrode active material 4 to obtain a mixture 7, adding the surfactant 5 thereto to mix with the mixture 7, by mixing the solvent and the surfactant 5 first, and then adding the negative electrode active material thereto, or by mixing the negative electrode active material 4 and the surfactant 5 first, and then dispersing the mixture in the solvent. FIG. 3A shows that the composition for forming a negative electrode active material layer is prepared by mixing the solvent and the negative electrode active material 4 to obtain the mixture 7, and then adding the surfactant 5 to the mixture 7, but the present disclosure is not limited thereto, and as described above, the composition for forming a negative electrode active material layer may be prepared by mixing the solvent and the surfactant first, and then adding the negative electrode active material thereto. Herein, the composition for forming a negative electrode active material layer, as far as it includes the negative electrode active material and the surfactant, may refer to both a liquid state in the form of a slurry of being dispersed in a solvent, and a solid state before being dispersed.

The type of the surfactant may be appropriately selected depending on the composition and material within the negative electrode active material layer, but for example, a natural surfactant, a synthetic surfactant, and the like, may be used as the surfactant. The natural surfactant may include, for example, an aliphatic hydrocarbon-based surfactant, which refer to a surfactant including aliphatic hydrocarbon, and examples of the aliphatic hydrocarbon-based surfactant may include at least one of fatty alcohol polyglycol ether (FAE), fatty alcohol sulfate (FAS), fatty alcohol ether sulfate (FAES), and methyl ester sulfonate (MES). The synthetic surfactant may include a hydrocarbon oil composed only of carbon and hydrogen, or a partial hydrocarbon surfactant having a hydrocarbon structure and a surfactant function. The hydrocarbon oil may include alkane, alkylbenzene, olefin, and the like, and the partial hydrocarbon surfactant may include ethylene oxide, alkylbenzenesulfonate, and the like. The types of the surfactant are not limited thereto.

The surfactant may have a colloidal form or a particle form. The surfactant is, for example, in the form of particles and has a particle size in a range of about 1 nm to about 90 nm, about 2 nm to about 70 nm, about 3 nm to about 50 nm, about 4 nm to about 30 nm, or about 5 nm to about 15 nm. The particle size of the surfactant may be measured according to a zeta potential measurement method, wherein the particle size of the surfactant may determine a width of the aforementioned lithium ion movement path in the negative electrode active material layer. A plurality of surfactant particles may gather to form one micelle, for example, the micelle may be formed of or include about 20 to about 100 surfactants. The micelle may be in the form of a particle, and a particle size of the micelle may be similar to or smaller than the width of the lithium ion movement path.

Because the surfactant is hydrophobic, the surfactant may be dispersed in the form of particles in an aqueous solvent. The surfactant mixed in the aqueous solvent may be in a state of a colloid, an emulsion, or oil-in-water.

The surfactant may be used in an amount in a range of about 0.01 parts by weight to about 20 parts by weight, based on 100 parts by weight of the negative electrode active material, for example, about 0.1 parts by weight to about 15 parts by weight, about 0.5 parts by weight to about 10 parts by weight, or about 2 parts by weight to about 7 parts by weight. When the surfactant is used within the above ranges, a high energy density may not only be realized, but also a tortuosity of a negative electrode plate may be reduced, which may resultantly improve or optimize the lithium ion movement path during the battery charging and discharging, and thus reduce or suppress the increase in internal resistance and the rapid charging degradation. When the surfactant is used in an amount of less than about 0.01 parts by weight, based on 100 parts by weight of the negative electrode active material, the lithium ion movement path may not be effectively formed, which may not reduce or suppress the increase in internal resistance and the rapid charging degradation. When the surfactant is used in an amount of greater than about 20 parts by weight, based on 100 parts by weight of the negative electrode active material, as the surfactant is more included, the negative electrode active material is relatively less included, failing in realizing high energy density. Specific details of the negative electrode current collector are as described above. Underneath the negative electrode current collector, a magnet may be placed. The magnet positioned under the negative electrode current collector may generate a magnetic field to be described below, which may arrange the negative electrode active material and the surfactant in a desired or predetermined direction.

Subsequently, after applying the composition 8 for forming a negative electrode active material layer on the negative electrode current collector 1, the magnetic field may be applied to the negative electrode to induce vertical orientation of the negative electrode active material 4. In other words, the negative electrode active material 4 in the composition 8 for forming a negative electrode active material layer applied on the negative electrode current collector 1 may be arranged in a vertical direction of the negative electrode current collector 1 due to the magnetic field, wherein the surfactant 5 may be placed between vertically-arranged negative electrode active material columns (FIG. 3B). The surfactant 5 placed between vertically arranged negative electrode active material columns may also be arranged approximately in the vertical direction of the negative electrode current collector 1.

The negative electrode active material may include a negative electrode active material with high electron conductivity, for example, a carbon-based negative electrode active material. The carbon-based negative electrode active material has an oval shape or an irregular shape with a sphericity of less than about 1 and also, high electron conductivity and thus may be readily arranged in a desired or predetermined direction by the magnetic field, for example, in a direction such that a major axis of the oval shape is approximately perpendicular to the current collector. The surfactant is hydrophobic and thus dispersed in the form of particles in the composition for forming a negative electrode active material layer, wherein when the negative electrode active materials are arranged in a vertical direction to the current collector due to the magnetic field, the surfactants may coagulate together between the negative electrode active material columns, and may also be arranged in the vertical direction.

The magnetic field may be formed by the magnet positioned under the negative electrode current collector, and may have intensity in a range of about 1000 Gauss to about 10000 Gauss, for example, about 2000 Gauss to about 9000 Gauss, or about 4000 Gauss to about 8000 Gauss. In addition, the mixed solution, after being applied on the negative electrode current collector, may be maintained for a duration in a range of about 1 second to about 15 seconds. In other words, the exposure of the composition 8 for forming a negative electrode active material layer to the magnetic field may be performed for about 1 second to about 15 seconds, or about 1 second to about 5 seconds. Depending on the magnetic field exposure time, the aforementioned DD values may be changed.

Subsequently, the surfactant 5 is dried (FIG. 3C). The negative electrode, in the state such that the negative electrode active material 4 and the surfactant 5 are arranged in the vertical direction to the negative electrode current collector 1, is dried to remove (evaporate or volatilize) the surfactant 5, forming a passage where the surfactant 5 is removed, which is the lithium ion movement path 6 according to some example embodiments. The drying may be performed at a temperature in a range of about 30° C. to about 200° C. for about 1 hour to about 24 hours. For example, the drying may be performed at about 40° C. to about 180° C., about 50° C. to about 160° C., or about 60° C. to about 140° C. for a duration in a range of about 1 hour to about 12 hours, about 1 hour to about 8 hours, or 1 about hour to about 5 hours. The drying time may vary depending on the drying temperatures. According to the drying process, the surfactant 5 and the solvent (not shown) may be removed to form a negative electrode active material layer 3 having the negative electrode active material 4 arranged in a vertical direction to the negative electrode current collector and the lithium ion movement path 6 positioned between the negative electrode active materials vertically arranged on the negative electrode current collector 1. The lithium ion movement path 6 may be formed by removing the surfactant 5 positioned between the negative electrode active materials 4 arranged in the vertical direction of the negative electrode current collector 1 through the drying process. Accordingly, the lithium ion movement path 6 may have a width affected by the particle size of the surfactant 5, wherein the width of the lithium ion movement path may be larger than or equal to the particle size to surfactant. In the drying step, the surfactant may be almost all removed, but may remain in a very small amount. For example, the surfactant may be included in an amount in a range of about 0 wt % to about 0.1 wt % or about 0.0001 wt % to about 0.01 wt % based on 100 wt % of the negative electrode active material layer.

The negative electrode according to the method may exhibit improved tortuosity and satisfy the aforementioned DD values.

After the drying step, the method for manufacturing the negative electrode may further include a compression step, thereby manufacturing a final negative electrode having the negative electrode active material layer on the negative electrode current collector.

### Rechargeable Lithium Battery

In some example embodiments, a rechargeable lithium battery includes a positive electrode, the aforementioned negative electrode, and an electrolyte.

### Positive Electrode

The positive electrode may include a positive electrode current collector, and a positive electrode active material layer on the positive electrode current collector.

The positive electrode active material layer includes a positive electrode active material, and may optionally further include a binder, a conductive material, or a combination thereof.

The positive electrode current collector is not particularly limited as long as the positive electrode current collector has conductivity and does not cause adverse chemical changes in the rechargeable lithium battery. In some example embodiments, the positive electrode current collector may be or include an aluminum foil.

As the positive electrode active material, a compound capable of intercalating and deintercalating lithium (lithiated intercalation compound) may be used. For example, at least one composite oxide of lithium and a metal such as or including at least one of cobalt, manganese, nickel, and a combination thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free lithium nickel-manganese-based oxide, a lithium-manganese-rich composite oxide, or a combination thereof.

As an example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0<c<0.5, 0<α<2); LiₐNi_{1-b-c}Mn_{b}X_{c}O_{2-α}D_{α} (0.90≤a≤1.8, 0≤b>0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may include at least one of a lithium nickel-based composite oxide represented by Chemical Formula 6, a lithium cobalt-based composite oxide represented by Chemical Formula 7, or a combination thereof.

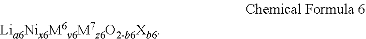

In Chemical Formula 6, 0.9≤a6≤1.8, 0.3≤x6≤1, 0≤y6≤0.7, 0≤z6≤0.7, 0.9≤x6+y6+z6≤1.1, and 0≤b6≤0.1, M⁶ and M⁷ each independently is or includes one or more of Al, B, Ba, Ca, Ce, Co, Cr, Cu, Fe, Mg, Mn, Mo, Nb, Si, Sn, Sr, Ti, V, W, and Zr, and X is or includes one or more of F, P, and S.

In Chemical Formula 6, 0.6≤x6≤1, 0≤y6≤0.4, and 0≤z6≤0.4; or 0.8≤x6≤1, 0≤y6≤0.2, and 0≤z6≤0.2.

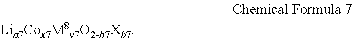

In Chemical Formula 7, 0.9≤a7<1.8, 0.7<x7<1, 0≤y7<0.3, 0.9≤x7+y7<1.1, and 0≤b7<0.1, M⁸ is or includes one or more of Al, B, Ba, Ca, Ce, Cr, Cu, Fe, Mg, Mn, Mo, Ni, Se, Si, Sn, Sr, Ti, V, W, Y, Zn, and Zr, and X is or includes one or more of F, P, and S.

In Chemical Formula 7, 0.8≤x7≤1, and 0≤y7≤0.2; or 0.7≤x7≤0.9, and 0≤y7≤0.2.

For example, the positive electrode active material may be or include a high nickel-based positive electrode active material in which the nickel content is greater than or equal to about 80 mol %, greater than or equal to about 85 mol %, greater than or equal to about 90 mol %, greater than or equal to about 91 mol %, or greater than or equal to about 94 mol %, and less than or equal to about 99 mol %, based on 100 mol % of metal excluding lithium in a lithium transition metal composite oxide. The high-nickel positive electrode active material may achieve high capacity, and may be applied to a high-capacity, high-density rechargeable lithium battery.

An amount of the positive electrode active material may be in a range of about 60 wt % to about 99.9 wt %, about 70 wt % to about 99.8 wt %, about 80 wt % to about 99 wt %, or about 90 wt % to about 99.8 wt %, or about 94 wt % to about 99 wt %, based on 100 wt % of the positive electrode active material layer.

The binder improves binding properties of positive electrode active material with one another and with a current collector. Examples of the binder may include at least one of polyvinyl alcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material may impart conductivity to the electrode, and any material that does not cause chemical change and conducts electrons can be used in the battery. Examples of the conductive material may include a carbon-based material such as at least one of natural graphite, artificial graphite, carbon black, acetylene black, Ketjen black, a carbon fiber, a carbon nanofiber, and carbon nanotube; a metal-based material including at least one of copper, nickel, aluminum, silver, and the like, in a form of a metal powder or a metal fiber; a conductive polymer such as a polyphenylene derivative; or a mixture thereof.

In the positive electrode active material layer, an amount of the binder may be in a range of about 0.1 wt % to about 5 wt %, or about 0.5 wt % to about 3 wt %, based on a total weight of the positive electrode active material layer, and a content of the conductive material may be in a range of about 0.1 wt % to about 5 wt %, or about 0.5 wt % to about 3 wt %, based on a total weight of the positive electrode active material layer.

Hereinafter, details regarding the negative electrode are omitted as they are the same as those described above.

### Electrolyte

For example, the electrolyte for a rechargeable lithium battery may be or include an electrolyte solution, which may include a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. For example, the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSl), LiC₄F₉SO₃, LiN(CₓF₂ₓ₊₁SO₂) (C_{y}F_{2y+1}SO₂), x and y are integers in a range of 1 to 20, lithium trifluoromethane sulfonate, lithium tetrafluoroethanesulfonate, lithium difluorobis(oxalato)phosphate (LiDFBOP), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one surface, or on both surfaces, of the porous substrate.

The porous substrate may be or include a polymer film formed of or including any one or more of polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (for example, TEFLON®), or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

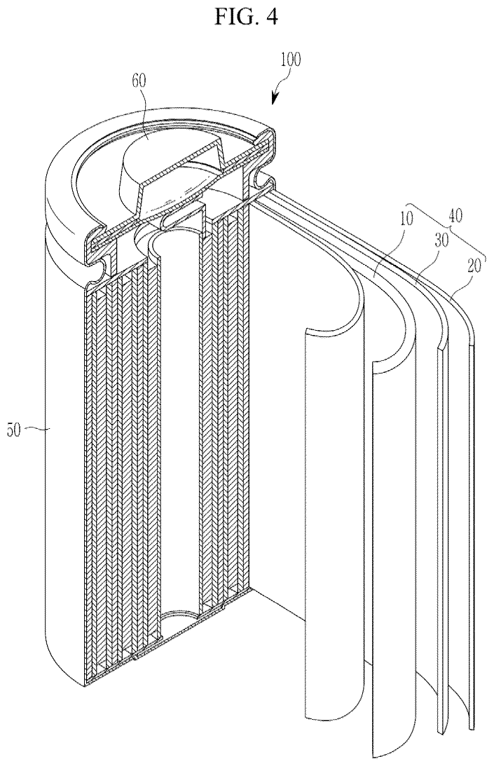

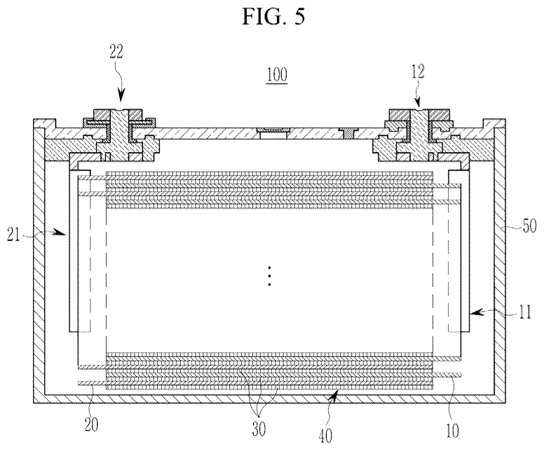

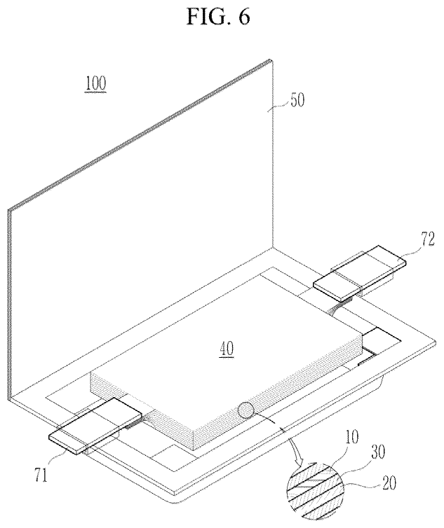

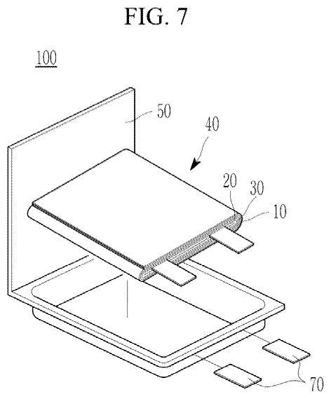

The rechargeable lithium battery may be classified into cylindrical, prismatic, pouch, coin, and the like depending on its shape. FIG. 4 to FIG. 7 are schematic views illustrating rechargeable lithium batteries according to some example embodiments. FIG. 4 shows a cylindrical battery, FIG. 5 shows a prismatic battery, and FIG. 6 and FIG. 7 show pouch-type batteries. Referring to FIG. 4 to FIG. 7, the rechargeable lithium battery 100 includes an electrode assembly 40 including a separator 30 between a positive electrode 10 and a negative electrode 20, and a case in which the electrode assembly 40 is included. The positive electrode 10, the negative electrode 20, and the separator 30 may be impregnated with an electrolyte (not shown). The rechargeable lithium battery 100 may include a sealing member 60 that seals the case 50 as shown in FIG. 4. Additionally, in FIG. 5, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 6 and FIG. 7, the rechargeable lithium battery 100 includes an electrode tab 70 illustrated in FIG. 7, or a positive electrode tab 71 and a negative electrode tab 72 illustrated in FIG. 6, the electrode tabs 70/71/72 forming an electrical path for inducing the current formed in the electrode assembly 40 to the outside of the battery 100.

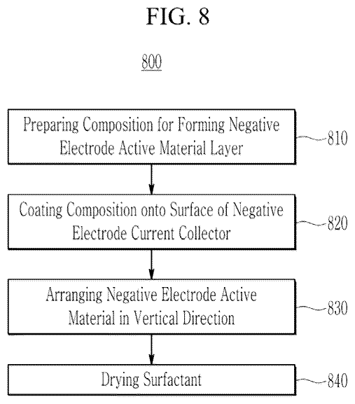

FIG. 8 is a flowchart illustrating a method of manufacturing a negative electrode for a rechargeable lithium battery, according to example embodiments. In FIG. 8, the method 800 includes operation 810 which includes preparing a composition for forming a negative electrode active material layer, the composition comprising a negative electrode active material and a surfactant. For example, the surfactant is in particle form, and a particle size of the surfactant is in a range of about 1 nm to about 90 nm. Operation 820 includes coating the composition for forming the negative electrode active material layer onto a surface of a negative electrode current collector. Operation 830 includes arranging the negative electrode active material in a vertical direction of the negative electrode current collector by a magnetic field, and arranging the surfactant between the negative electrode active materials arranged in the vertical direction. Operation 840 includes drying the surfactant. For example, the drying of the surfactant is carried out at a temperature in a range of about 30° C. to about 200° C.

Examples and comparative examples of the present disclosure are described below. However, the following examples are only examples of the present disclosure, and the present disclosure is not limited to the following examples.

### Example 1

### (1) Manufacturing of Negative Electrode

Artificial graphite as a negative electrode active material, a mixture of styrene butadiene rubber and carboxylmethyl cellulose in a weight ratio of 16:7 as a binder, and carbon nanotube as a conductive material were mixed in a weight ratio of 96.25:3.67:0.08 (=negative electrode active material:binder:conductive material) and then, dispersed in a distilled water solvent to prepare a mixture.

Subsequently, hydrocarbon oil with a particle size of 10 nm as a surfactant was added to the mixture and then, mixed together to prepare a composition for forming a negative electrode active material layer. Herein, 96.2 parts by weight of the solvent was used, based on 100 parts by weight of the negative electrode active material, and 5 parts by weight of the added surfactant was used, based on 100 parts by weight of the negative electrode active material.

The composition for forming a negative electrode active material layer was applied on a negative electrode current collector of a copper foil with a magnet attached to the bottom to arrange the negative electrode active material and the surfactant in a vertical direction of the negative electrode current collector due to a magnetic field of the magnet. Herein, the magnetic field had intensity of about 6000 Gauss expose, and exposure time thereto was 1.2 seconds.

Subsequently, the applied composition for forming a negative electrode active material layer was dried at 100° C. for 3 hours to remove the surfactant and the solvent, manufacturing a negative electrode having the negative electrode active materials arranged in the vertical direction of the negative electrode current collector and a lithium ion movement path located between the negative electrode active materials arranged in the vertical direction.

### (2) Manufacturing of Rechargeable Lithium Battery Cell

A positive electrode active material composition was prepared by mixing LiNi_{0.94}Co_{0.04}Al_{0.1}Mn_{0.01}O₂ as a positive electrode active material, polyvinylidene fluoride as a binder, and carbon nanotube as a conductive material in a weight ratio of 96:2:2 (positive electrode active material:binder:conductive material). This positive electrode active material composition was dispersed in an N-methyl pyrrolidone solvent to prepare a positive electrode active material slurry, which was coated on a 15 μm-thick aluminum foil and then, dried and compressed to manufacture a positive electrode.

A 10 μm-thick polyethylene separator was interposed between the positive electrode and the negative electrode to manufacture an electrode assembly, which was inserted into a case, and an electrolyte was injected thereinto, manufacturing a rechargeable lithium battery cell (100 mAh level pouch cell). The electrolyte was prepared by mixing EC (ethylene carbonate):EMC (ethylmethyl carbonate):DMC (dimethyl carbonate) in a volume ratio of 2:4:4 and dissolving 1.15 M LiPF₆ in the mixed solvent.

### Examples 2 to 10

Each negative electrode and rechargeable lithium battery cell were manufactured in the same manner as in Example 1, with a difference that the particle size of the surfactant, the thickness of the negative electrode active material layer. and the like were changed in the manufacture of the negative electrode of Example 1, as shown in Table 1 below. Subsequently, a width of each lithium ion movement path formed according as changed above and a ratio of the width of the lithium ion movement path to an entire width of each negative electrode active material layer were measured through a scanning electron microscope (SEM) image of each negative electrode cross-section, and the results are shown in Table 1 below.

### Comparative Examples 1 and 2

Each negative electrode and rechargeable lithium battery cell were manufactured in the same manner as in Example 1, with a difference that the surfactant was not added in the manufacture of the negative electrode of Example 1. In Comparative Example 1 to 2 using no surfactant, the lithium ion movement path was not formed unlike Example 1, and therefore, the width of the lithium ion movement path and the ratio of the width of the lithium ion movement path to the width of the negative electrode active material layer in Table 1 could not be measured.

TABLE 1

| | | | | Ratio (%) of the |
|---|---|---|---|---|
| | | Thickness | | total width of |
| | | (μm) of | Width | the lithium |
| | | negative | (μm) of | ion movement path |
| | Particle | electrode | lithium | to the total width |
| | size | active | ion | of the negative |
| | (nm) of | material | movement | electrode active |
| | surfactant | layer | path | material layer |
| Example 1 | 10 | 73.35 | 6 | 2 |
| Example 2 | 30 | 71.75 | 12 | 6 |
| Example 3 | 50 | 71.26 | 22 | 12 |
| Example 4 | 70 | 75.26 | 30 | 15 |
| Example 5 | 90 | 74.51 | 38 | 20 |
| Example 6 | 10 | 57.49 | 5 | 2 |
| Example 7 | 30 | 57.18 | 12 | 5 |
| Example 8 | 50 | 56.89 | 20 | 11 |
| Example 9 | 70 | 58.02 | 29 | 14 |
| Example 10 | 90 | 57.94 | 36 | 18 |
| Comparative | — | 74.86 | — | — |
| Example 1 | | | | |
| Comparative | — | 57.35 | — | — |
| Example 2 | | | | |

### Evaluation Example 1. Internal Resistance Measurement

The ion resistance (Rᵢₒₙ) of the negative electrodes of Examples 1 to 10 and Comparative Examples 1 and 2 was measured by EIS (electrochemical impedance spectroscopy) using a potentiostat (ZIVE BP2A, WonATech Co., Ltd., Korea) within a frequency range of 100 KHz to 1 Hz, at an open-circuit voltage (OCV) of the cell, with an amplitude of 20 mV at 25° C. The internal resistance was calculated by multiplying the measured ion resistance and an area of each electrode, and the results are shown in Table 2 below.

### Evaluation Example 2. Calculation of McMullin Number

The negative electrodes of Examples 1 to 10 and Comparative Examples 1 and 2 were calculated with respect to Macmullin number (N_{M}) according to Equation 1, and the results are shown in Table 2 below.

$$\begin{matrix}Equation 1 & \\ {N}_{M} = \frac{{R}_{ion} \cdot A \cdot {σ}_{o}}{d} . & ( 1 )\end{matrix}$$

In the above Equation 1, Rᵢₒₙ is an ionic resistance of a negative electrode (Ω), A is an area (cm²) of an electrode, σₒ is an ionic conductivity of an electrolyte (Scm⁻¹), and d is a thickness of an electrode (μm).

The Rᵢₒₙ used the ion resistance (Rᵢₒₙ) of the negative electrode measured in Evaluation Example 1, and the ionic conductivity of an electrolyte was a product specification of an electrolyte manufacturer (Starlyte from Panax Etec Co., Ltd., Busan, Korea), and the thickness of an electrode was measured by using a micrometer (SM293-025, Sincon).

TABLE 2

| | Internal resistance | N_{M} |
|---|---|---|
| | (Ω cm²) | (Macmullin number) |
| Example 1 | 11.73 | 15.68 |
| Example 2 | 11.49 | 15.57 |
| Example 3 | 11.26 | 15.34 |
| Example 4 | 11.08 | 15.13 |
| Example 5 | 10.93 | 15.05 |
| Example 6 | 11.13 | 14.15 |
| Example 7 | 11.02 | 13.92 |
| Example 8 | 10.86 | 13.68 |
| Example 9 | 10.64 | 13.50 |
| Example 10 | 10.48 | 13.35 |
| Comparative Example 1 | 11.85 | 15.82 |
| Comparative Example 2 | 11.20 | 14.27 |

### SUMMARY

Referring to Table 2 above, comparing Example 1 to 5 with Comparative Example 1, which had an almost similar thickness of a negative electrode active material layer, the negative electrodes of Examples 1 to 5 manufactured by using the surfactant, compared to the negative electrode of Comparative Example 1 manufactured by not using the surfactant, confirms that the internal resistance and the McMullin number of negative electrode were reduced. In addition, comparing Examples 6 to 10 with Comparative Example 2, which had an almost similar thickness of a negative electrode active material layer, Examples 6 to 10, of which the negative electrodes were manufactured by adding the surfactant, compared with Comparative Example 2, of which the negative electrode was manufactured by not adding the surfactant, confirms that the internal resistance and the McMullin number of the negative electrodes were reduced as shown in Table 2 above. Accordingly, Examples 1 to 5 or 6 to 10, in which the composition for forming a negative electrode active material layer was prepared by adding the surfactant to a mixture of a negative electrode active material, and then coated on a negative electrode current collector so that the negative electrode active material and the surfactant were arranged in a vertical direction of the negative electrode current collector due to a magnetic field generated from a magnet to form a lithium ion movement path, reduced the negative electrode internal resistance and the McMullin number, compared with Comparative Example 1 or 2, and thereby may be predicted to improve or optimize the lithium ion movement path and reduce or suppress the increase in internal resistance and the deterioration of rapid charging performance.

On the other hand, comparing Examples 1 to 5 with 6 to 10 using the surfactant with the same particle size but using a different thickness of the negative electrode active material layer, it can be concluded that the thinner the negative electrode active material layer, the lower the negative electrode internal resistance and the McMullin number.

In addition, Examples 1 to 5 having similar thicknesses showed that the larger particle size of the surfactant, the lower the negative electrode internal resistance and the McMullin number, which confirmed that the lithium ion movement path was substantially better or more optimally formed to have a size equal to or larger than the sized of a micelle formed of or including a plurality of surfactants gathered together.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the appended claims.

### DESCRIPTION OF SYMBOLS

| | |
|---|---|
| 1: negative electrode current collector | |
| 2: conventional negative electrode | |
| active material layer | |
| 3: negative electrode active material | |
| layer | |
| 4: negative electrode active material | |
| 5: surfactant | 6: lithium ion movement path |
| 7: mixture | |
| 8: composition for forming the negative | |
| electrode active material layer | |
| 100: rechargeable lithium battery. | 10: positive electrode |
| 11: positive electrode lead tab | 12: positive electrode terminal |
| 20: negative electrode | 21: negative electrode lead tab |
| 22: negative electrode terminal. | 30: separator |
| 40: electrode assembly | 50: case |
| 60: sealing member | 70: electrode tab |
| 71: positive electrode tab | 72: negative electrode tab |

What is claimed is:

1. A negative electrode for a rechargeable lithium battery, the negative electrode comprising:
a negative electrode current collector; and
a negative electrode active material layer disposed on the negative electrode current collector and comprising a negative electrode active material;
wherein the negative electrode active material is arranged in a vertical direction of the negative electrode current collector,
the negative electrode active material layer has a lithium ion movement path between negative electrode active materials arranged in a vertical direction, and
a width of the movement path is in a range of about 1 μm to about 50 μm.

2. The negative electrode for a rechargeable lithium battery as claimed in claim 1, wherein the negative electrode active material comprises a carbon-based negative electrode active material.

3. The negative electrode for a rechargeable lithium battery as claimed in claim 2, wherein the negative electrode active material further comprises a silicon-based negative electrode active material.

4. The negative electrode for a rechargeable lithium battery as claimed in claim 1, wherein an amount of the negative electrode active material is in a range of about 90 wt % to about 99.9 wt % based on 100 wt % of the negative electrode active material layer.

5. The negative electrode for a rechargeable lithium battery as claimed in claim 1, wherein the lithium ion movement path extends in a vertical direction of the negative electrode current collector.

6. The negative electrode for a rechargeable lithium battery as claimed in claim 1, wherein the lithium ion movement path has an open structure that connects one side of the negative electrode active material layer in contact with the negative electrode current collector to the other side facing the one side.

7. The negative electrode for a rechargeable lithium battery as claimed in claim 1, wherein the lithium ion movement path extends in multiple numbers within the negative electrode active material layer.

8. The negative electrode for a rechargeable lithium battery as claimed in claim 1, wherein a ratio (b/a) of the width (b) of the lithium ion movement path to a width (a) of the negative electrode active material layer is in a range of about 1% to about 30%.

9. The negative electrode for a rechargeable lithium battery as claimed in claim 1, wherein a length of the lithium ion movement path is in a range of about 5 μm to about 200 μm.

10. The negative electrode for a rechargeable lithium battery as claimed in claim 1, wherein a tortuosity of the lithium ion movement path in the negative electrode active material layer is in a range of about 1 to about 3.

11. The negative electrode for a rechargeable lithium battery as claimed in claim 1, wherein:
the negative electrode has a Degree of Divergence (DD) value defined by Equation 1 that is greater than or equal to about 19:
$$DD ( Degree of Divergence ) = ( {I}_{a} / {I}_{total} ) \times 100 ; \qquad Equation 1$$
wherein, in Equation 1:
Iₐ is a sum of peak intensities at non-planar angles measured by XRD using a CuKα ray, and
Iₜₒₜₐₗ is a sum of peak intensities at all angles measured by XRD using a CuKα ray.

12. The negative electrode for a rechargeable lithium battery as claimed in claim 1, wherein the negative electrode active material layer further comprises a surfactant.

13. A method for manufacturing a negative electrode for a rechargeable lithium battery, the method comprising:
preparing a composition for forming a negative electrode active material layer, the composition comprising a negative electrode active material and a surfactant;
coating the composition for forming the negative electrode active material layer onto a surface of a negative electrode current collector;
arranging the negative electrode active material in a vertical direction of the negative electrode current collector by a magnetic field, and arranging the surfactant between the negative electrode active materials arranged in the vertical direction; and
drying the surfactant.

14. The method as claimed in claim 13, wherein:
the surfactant is in particle form; and
a particle size of the surfactant is in a range of about 1 nm to about 90 nm.

15. The method as claimed in claim 13, wherein the drying of the surfactant is carried out at a temperature in a range of about 30° C. to about 200° C.

16. A rechargeable lithium battery, comprising:
a positive electrode;
the negative electrode as claimed in claim 1; and
an electrolyte.
